(19) United States
(12) Patent Application Publication
(10) Pub. No.: US 2014/0292045 A1
(43) Pub. Date: Oct. 2, 2014

(54) Mechanism for Increasing the Distance Traveled During a Forceful Change in Velocity

(71) Applicant: Daniel Halterman Jeffery, Clearwater, FL (US)

(72) Inventor: Daniel Halterman Jeffery, Clearwater, FL (US)

(21) Appl. No.: 13/853,388

(22) Filed: Mar. 29, 2013

(51) Int. Cl. B60N 2/427

(52) U.S. Cl. CPC B60N 2/427
USPC 297/216.11; 297/216.1

(57) ABSTRACT

A mechanism in which comprises of the assembly of a slide and a track. A seat is to be attached to a slide, and a track to be attached to a vehicle or a base for a child seat. The seat attached to a slide will move along the length of the track in response to a forceful change in velocity through the inertia and/or momentum applied from the mass of the object(s) attached to the slide. A braking mechanism can be used to slow the change in velocity while the slide is moving along the track. Multiple slide and track assemblies may be used together to give motion in multiple axes.

The mechanism has the ability to be designed with a slide attached to the vehicle and a track attached to the seat. For ease of understanding, references to the mechanism herein disclosed will be to a mechanism which is designed for a track to be attached to the vehicle and a slide attached to the seat. Referring to the mechanism in this manor will not change the effectual purpose of the invention not the ability to understand the scope of the invention.

This application claims priority to U.S. Patent Application Ser. No. 61/618,323 filed Mar. 30, 2012, which is herein incorporated in its entirety

### BACKGROUND OF THE INVENTION

This invention relates to a mechanism for use in a vehicle, and more particularly a mechanism in which to increase the distance traveled of a person in a vehicle during a forceful change in velocity.

There are many safety features that are integrated into vehicular seats. Some safety features that are typically used with vehicular seats are padding, and seat belts or harnesses. Padding uses a cushioning effect by increasing the distance traveled while slowing the change in velocity along the distance traveled; Seat belts and harnesses are used to keep the passenger in the vehicle, thus preventing further damage from impact with objects inside and/or outside the vehicle. Seat belts and harnesses are typically constructed from a material that is designed to stretch or accompanies by a seat belt pretensioner to give the same effect. The stretch of the seat belt or harness also has a cushioning effect.

### BRIEF SUMMARY OF THE INVENTION

The purpose of this invention is to provide a mechanism in which increases the distance traveled during a forceful change in velocity. The invention can be used with different forms of seats. A few different types of seats this mechanism can be designed for use are infant vehicular seats, toddler vehicular seats, booster seats, and standard adult vehicular seats.

The main function of this invention is for a seat to be positioned on a slide that is able to move along a track. The assembly of the slide and track can be placed with multiple slide and track assemblies at different angles in order to give a full range of motion in the X, Y, and/or Z axis.

During a forceful change in velocity, the seat attached to the slide will move along the track in response to the change through its inertia or momentum. A braking mechanism is used to slow the movement of the slide along the length of the track

It is therefore a general object of this invention to provide a mechanism in which increases the distance traveled of a person while a forceful change in velocity is occurring.

It is another object of this invention for a slide to be able to move along a track.

It is still another object of this invention for multiple slide and track assemblies to be used together to give movement in multiple axes.

A further object of this invention is to use a braking mechanism to slow the movement of a slide moving along a track.

Still another object of this invention is for a slide and track assembly, or assemblies, to be attached to a vehicle.

It is yet another object of this invention for a seat to be attached to a slide and track assembly that is attached to the vehicle.

It is still another object of this invention for a slide and track assembly to be able to be made in a curved fashion.

It is further another object of this invention for a slide and track assembly to further comprise a guide to restrict movement to only along the length of the track.

It is yet another object of this invention for a track to have end stops on either side of the track to prevent a slide from moving off the track.

Other objects and advantages of this invention will become apparent from the following description taken in connection with the accompanying drawings, wherein is set forth by way of illustration and example, an embodiment of this invention

### BRIEF DESCRIPTION OF THE DRAWINGS

FIG. 1 is a top view of a single slide and track assembly.

FIG. 2 is a front view of the single track assembly shown in FIG. 1.

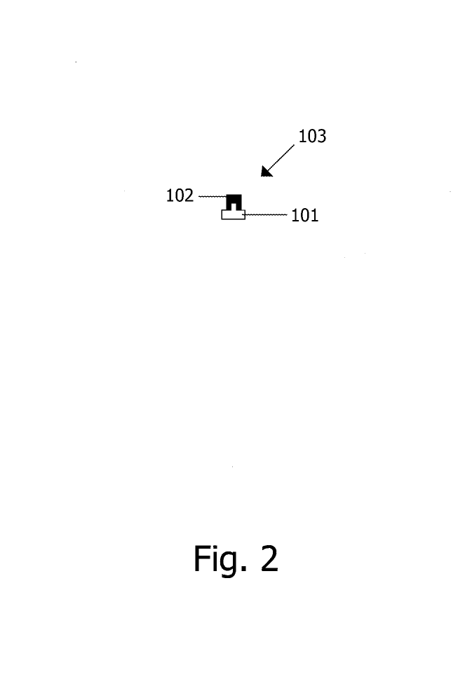

FIG. 3 is a top view of a single slide and track assembly with an end stop on both the front and back of the track

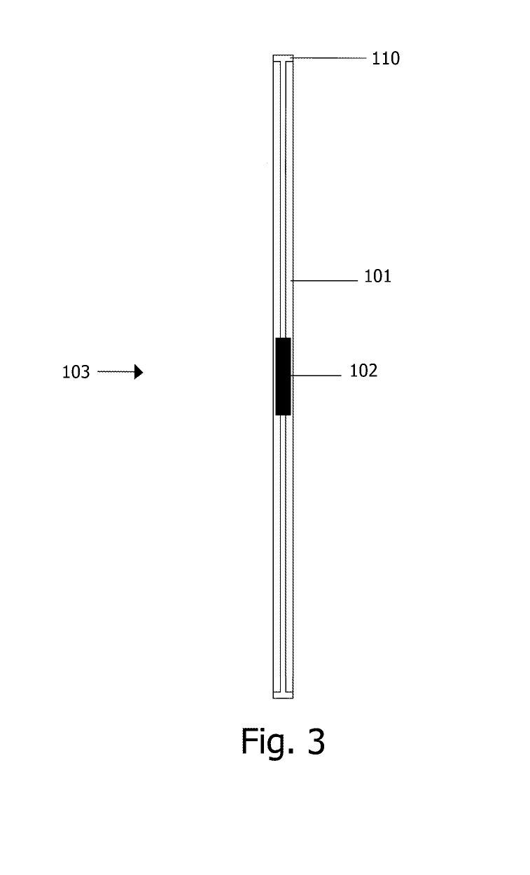

FIG. 4 is a front view of a single slide and track assembly with an end stop on both the front and back of the track.

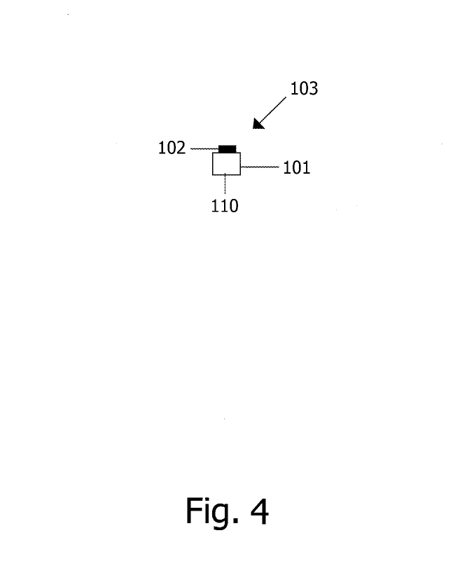

FIG. 5 is a front view of a single slide and track assembly with a guided track.

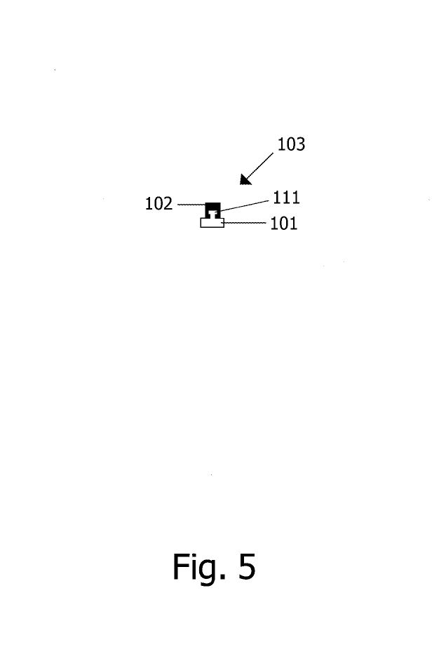

FIG. 6 is a top view of two slide and track assemblies placed parallel to each other.

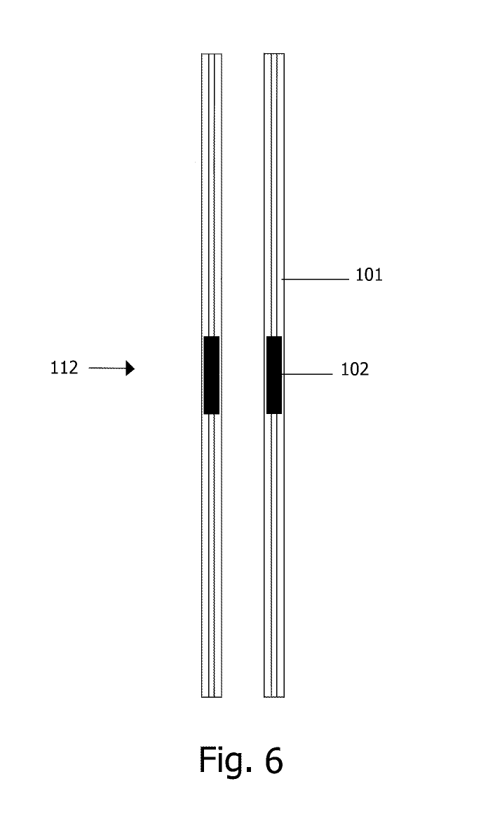

FIG. 7 is a top view of a slide and track assembly attached on top of another slide and track assembly at a 90° angle.

FIG. 8 is a front view of FIG. 7.

FIG. 9 is a front view of three slide and track assemblies attached together at 90° angles, giving motion in the X, Y, and Z axes.

FIG. 10 is a top view of the slide and track assemblies shown in FIG. 7 with force being applied towards the left.

FIG. 11 is a top view of the slide and track assemblies shown in FIG. 7 with force being applied towards the front.

FIG. 12 is a top view of the slide and track assemblies shown in FIG. 7 with equal amounts of force being applied towards both the left and the front.

FIG. 13 is a left side cutaway view of an adult seat that has a single track assembly installed.

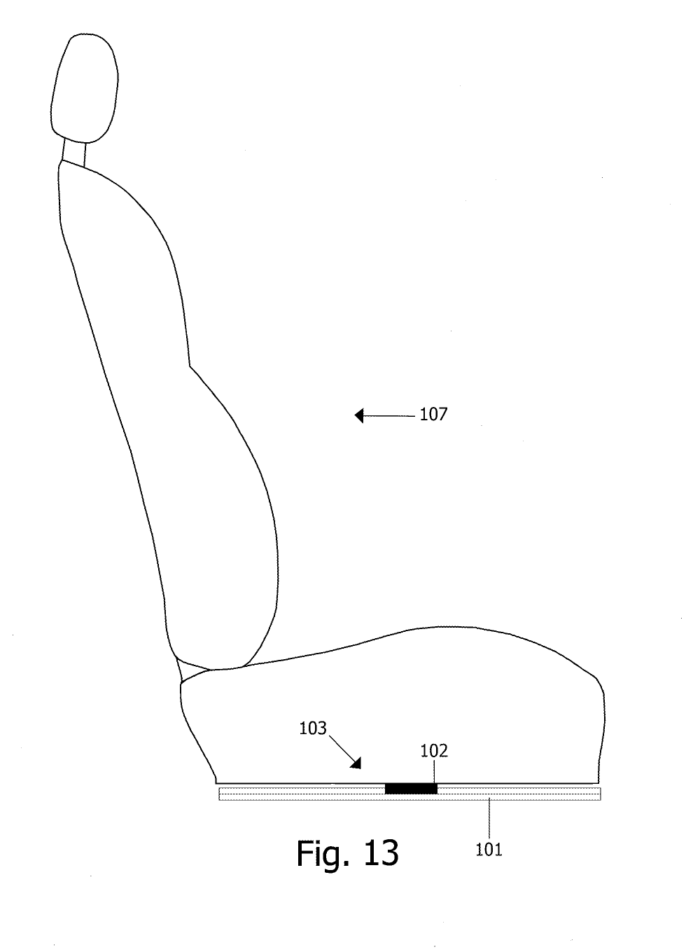

FIG. 14 is a left side cutaway view of an adult seat that has two slide and track assemblies installed to give motion in the X and Y axes.

FIG. 15 is a view of the seat shown in FIG. 13 with force being applied towards the front of the seat.

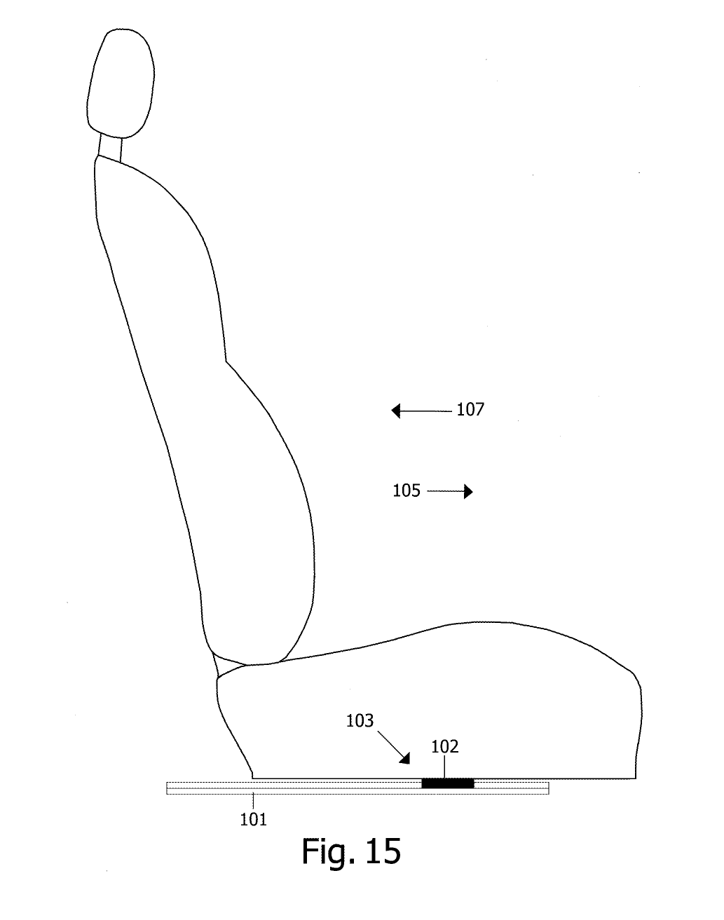

FIG. 16 is a left side cutaway view of an infant seat that has a single slide and track assembly installed in the base of the seat.

FIG. 17 is a left side cutaway view of an infant seat that has two slide and track assemblies installed inside of the base of the seat to give motion in the X and Y axes.

FIG. 18 is a view of the infant seat shown in FIG. 17 with force being applied towards the front of the seat.

### DETAILED DESCRIPTION OF THE INVENTION

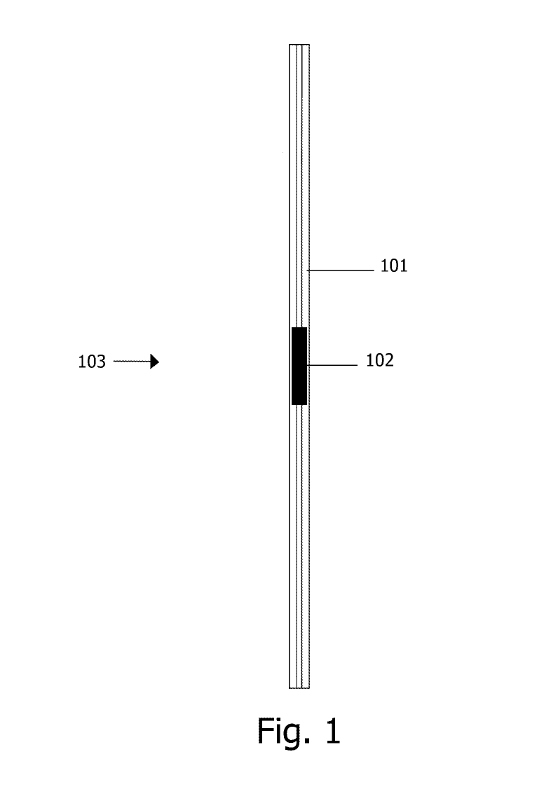

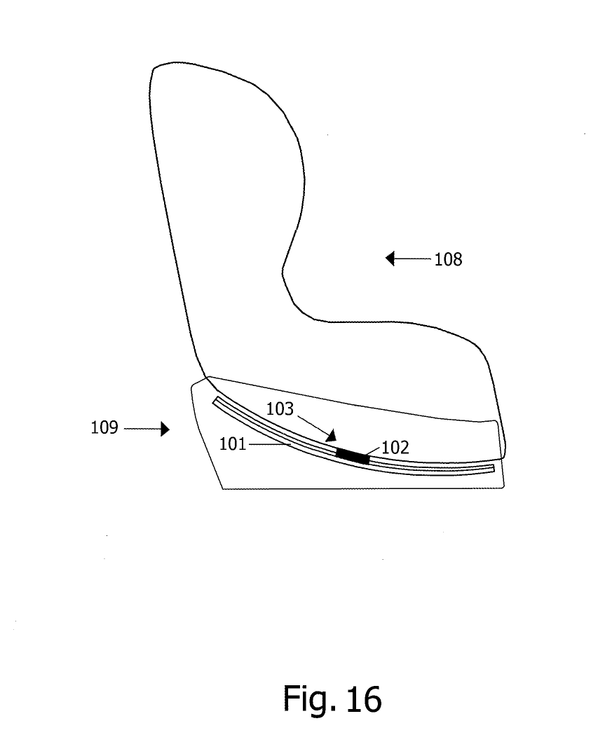

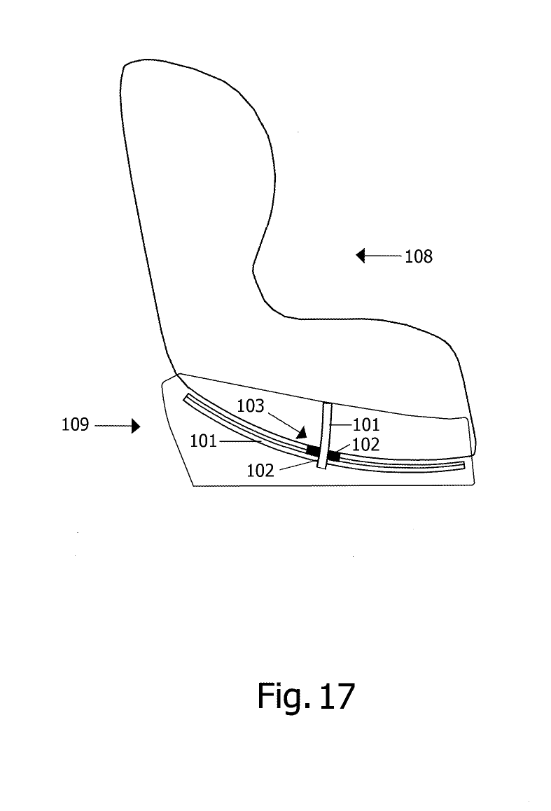

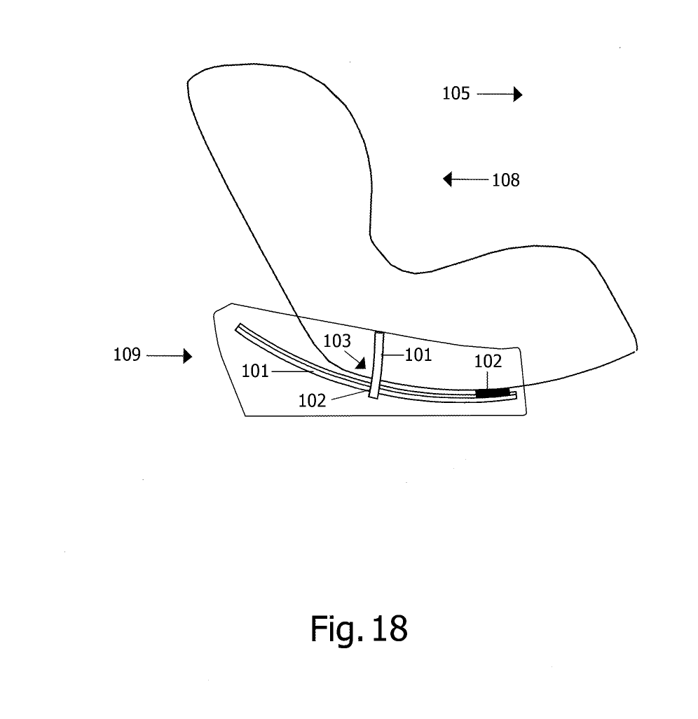

As shown in FIG. 1, the invention comprises of a track 101, with a slide 102 that can move along the length of the track 101. A braking mechanism is incorporated into either the track 101 or the slide 102, or both. Preferably, the track 101 is attached to a vehicle, or seat base 108 and the slide is attached to the seat 107, or child seat base 109. As shown in FIGS. 16, 17, and 18, the slide 102 and track 101 can also be used with a child car seat.

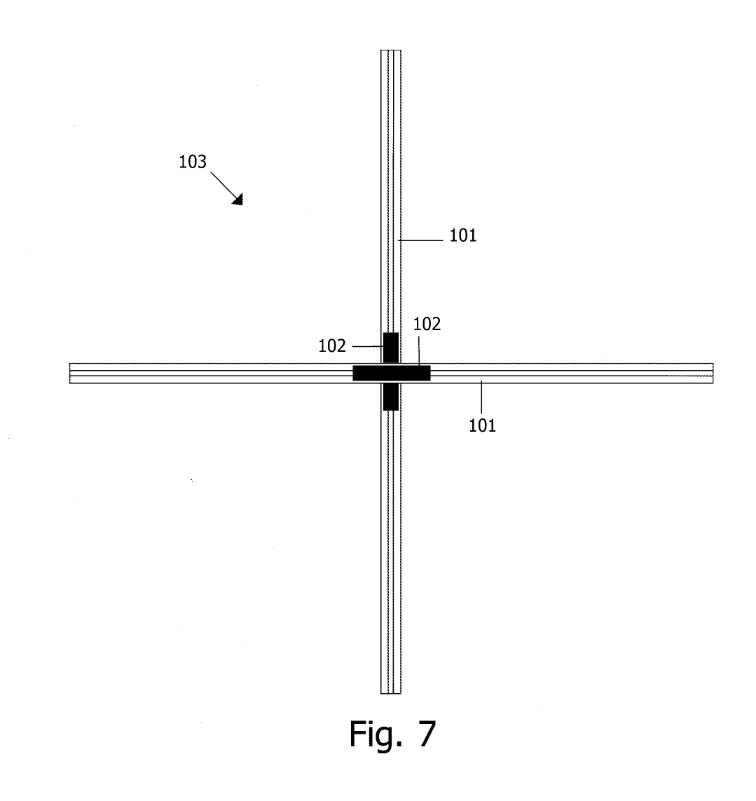

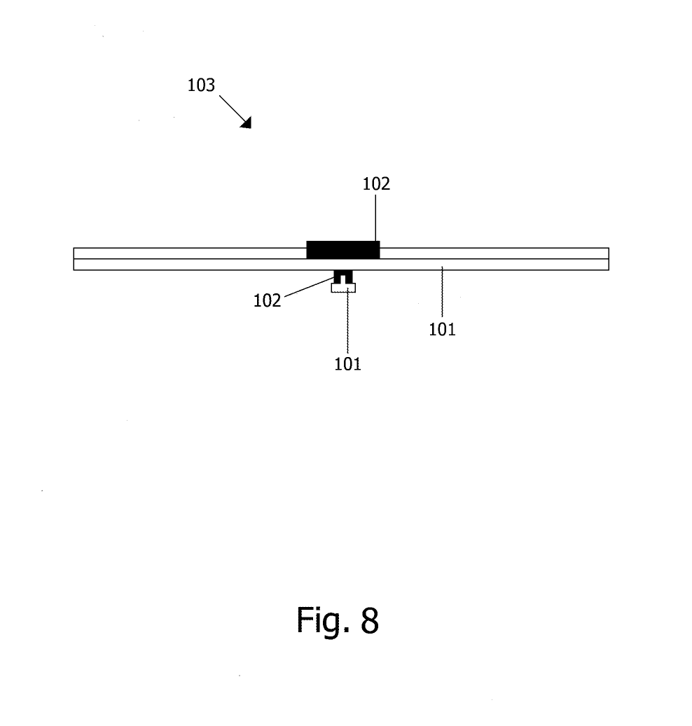

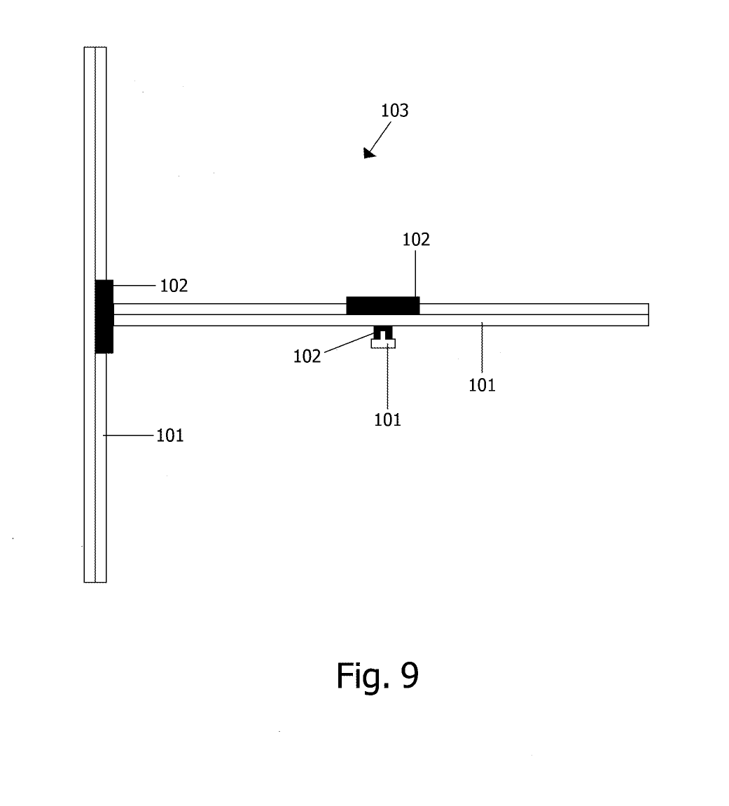

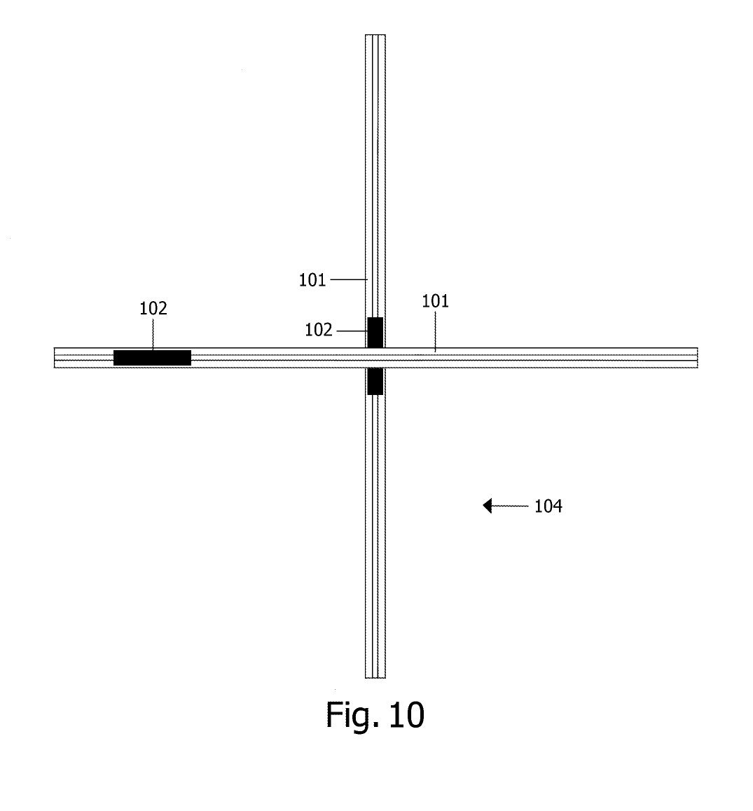

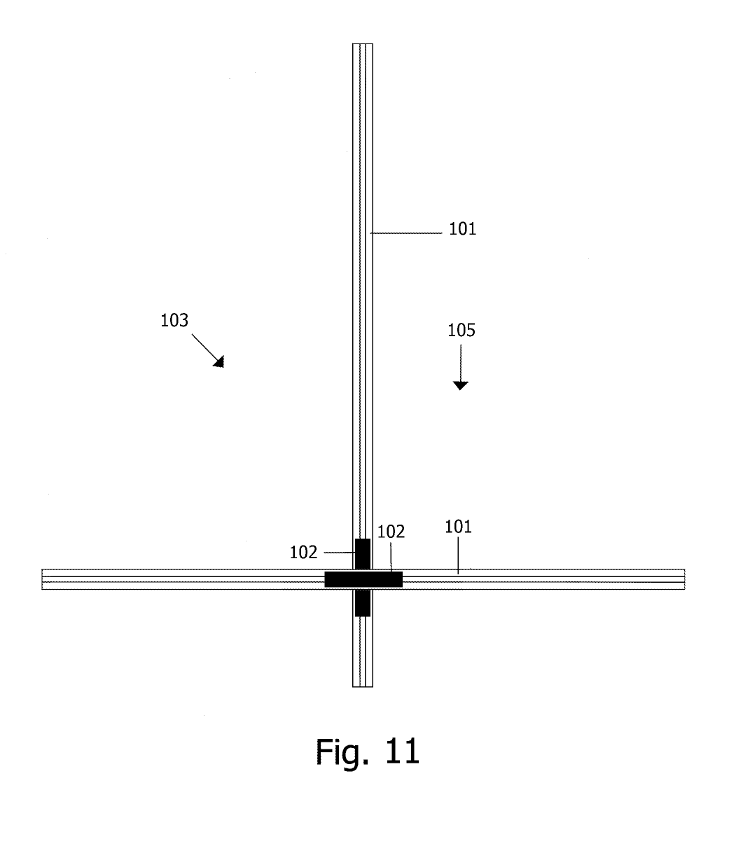

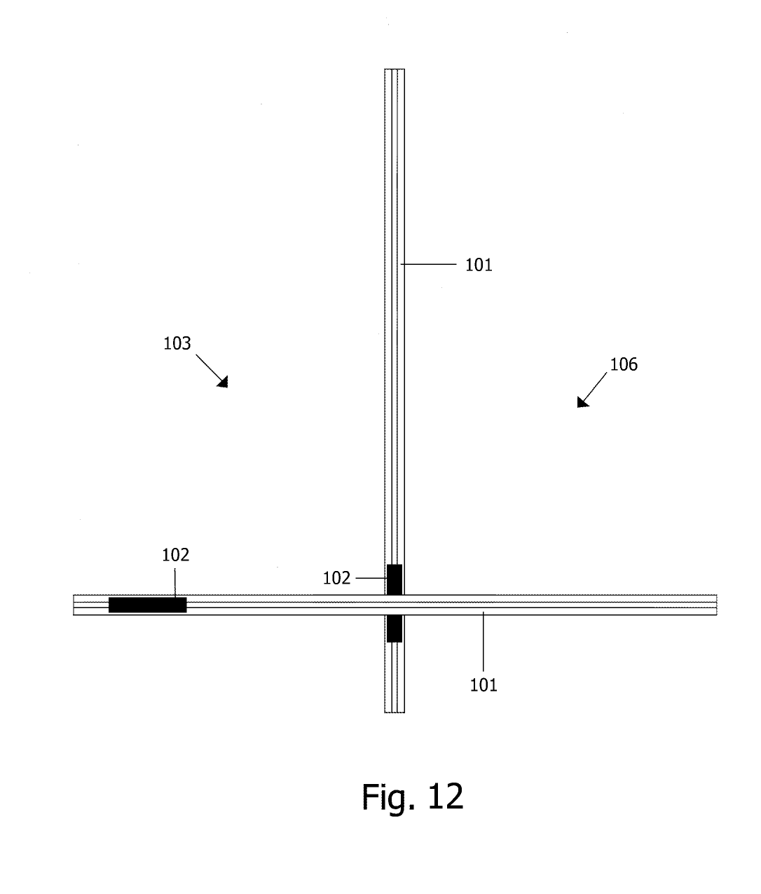

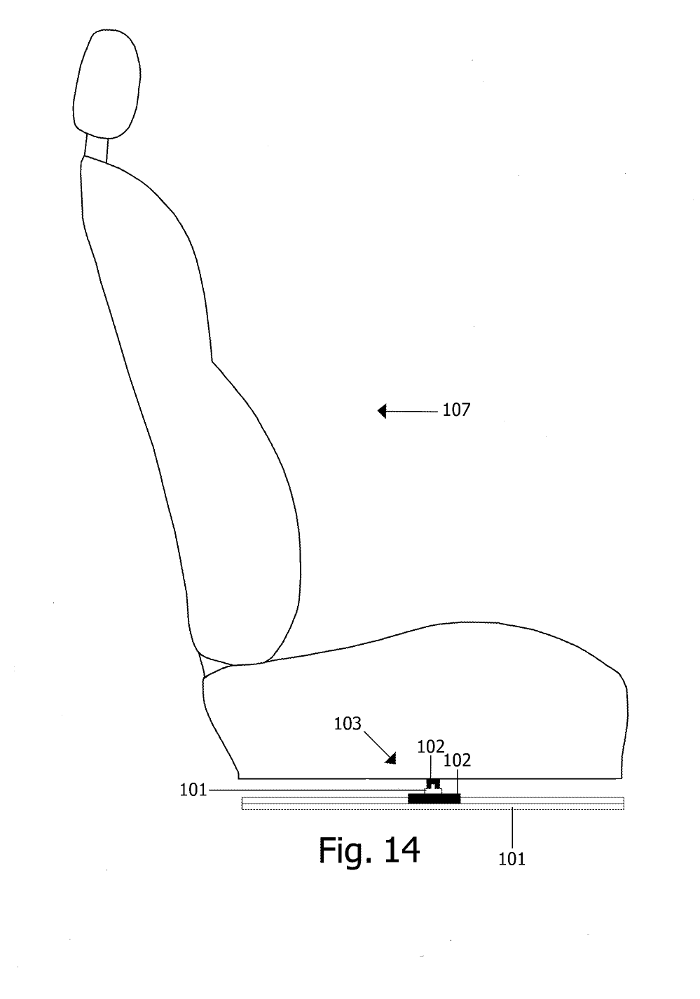

If movement is to be needed in two axes, the attachment of a second slide and track assembly 103 at a substantially perpendicular angle to the first slide and track assembly 103 can give movement in the X and Y axes. If movement is to be needed in three axes, the attachment of a third slide and track assembly 103 at a substantially perpendicular angle to said first slide and track assembly 103 and said second slide and track assembly 103 can give movement in the X, Y, and Z axes. Assemblies that can give movement in only the X axis are shown in FIGS. 1,2,3,4,5, 6, 13, 15, and 16. Assemblies that can give movement in both the X and Y axes are shown in FIGS. 7, 8, 10, 11, 12, 14, 17, and 18. An assembly that can give movement in the X, Y, and Z axes is shown in FIG. 9.

The track 101 and slide 102 should be made of very strong and hard materials, such as a metal or composite material. Braking mechanisms that can be used with this invention can vary greatly and can be incorporated with the slide 102, the track 101, or both the slide 102 and the track 101, or in any other fashion deemed necessary by those skilled in the art. The following is a list of a few of the possible braking mechanisms with a short description of the basic functioning of each braking mechanism.

A friction braking mechanism would work by using friction to slow the movement of the slide 102 along the track 101.

Another mechanism for braking could be by the physical alteration of a material. In this method, energy transferred from the inertia and/or momentum of the object(s) being protected is used to physically alter the shape or form of a material.

Yet another possible mechanism for braking could be the compression and/or decompression of springs or an elastic material.

Still, another braking mechanism could use magnetic or electromagnetic forces to provide resistance.

A further mechanism for braking could use hydraulic forces to provide resistance.

It is understood that the distance traveled by the slide 102 along the track 101 is dependent on the amount of force applied to move the person or object(s) attached to the slide 102 and the amount of resistance provided by the braking mechanism.

The slide and track assembly 103 can be curved as shown in FIGS. 16, 17, and 18. An advantage of a curved slide and track assembly 103 is that while the slide 102 is moving along the track 101, the centrifugal force generated by moving in a curved path can help redistribute the direction of force applied to the person or object(s) using the invention.

It will be understood that changes in the details, materials, steps, and arrangements of parts which have been described and illustrated to explain the nature of the invention will occur to and may be made by those skilled in the art upon a reading of this disclosure within the principals and scope of the invention. The foregoing description illustrates the preferred embodiment of the invention; however, concepts, as based upon the description, may be employed in other embodiments without departing from the scope of the invention.

Having thus described the invention, what is claimed is:

1. A safety apparatus for a vehicle seat comprising:
a. a first track, attached to a substantially immovable object in a vehicle;
b. a first slide assembly, slidably connected to said track ;
c. a vehicle seat, attached to said slide assembly; and
d. a braking mechanism configured to provide substantial resistance to the slide assembly along said track.

2. The apparatus of claim 1, further comprising a second track, wherein said first track and second track are positioned at substantially perpendicular angles relative to one another.

3. The apparatus of claim 2, further comprising a third track, wherein said third track is substantially perpendicular to said first track and said second track.

4. The apparatus of claim 1, wherein said first track further comprises at least one end stop member.

5. The apparatus of claim 1 wherein said first track is substantially curved.

6. The apparatus of claim 1, wherein said vehicle seat is a child seat.

7. The apparatus of claim 1, wherein said vehicle seat is an adult seat.

8. The apparatus of claim 1, wherein said substantially immovable object is a vehicle frame.

9. The apparatus of claim 1, wherein said substantially immovable object is a vehicle seat.

10. The apparatus of claim 1, wherein said braking mechanism further comprises at least one compression spring.

11. The apparatus of claim 1, wherein said braking mechanism further comprises at least one decompression spring.

12. The apparatus of claim 1, wherein said braking mechanism provides resistance by way of electromagnetic forces.

13. The apparatus of claim 1, wherein said braking mechanism provides resistance by way of frictional forces.

14. The apparatus of claim 1, wherein said braking mechanism provides resistance by way of hydraulic forces.
